(19) United States
(12) Patent Application Publication
(10) Pub. No.: US 2015/0217532 A1
(43) Pub. Date: Aug. 6, 2015

(54) METHOD OF MANUFACTURING A LAMINATE PROVIDED WITH A CONCAVE-CONVEX STRUCTURE AND TRANSFER FILM

(71) Applicant: Toray Industries, Inc., Tokyo (JP)

(72) Inventors: Emi Kuraseko, Otsu-shi (JP); Susumu Takada, Otsu-shi (JP); Motoyuki Suzuki, Otsu-shi (JP); Shotaro Tanaka, Otsu-shi (JP)

(21) Appl. No.: 14/421,001

(22) PCT Filed: Jul. 26, 2013
(86) PCT No.: PCT/JP2013/070291

§ 371 Date: Feb. 11, 2015

(30) Foreign Application Priority Data
Sep. 13, 2012 (JP) 2012-201191

(51) Int. Cl. B32B 3/30; B32B 38/10; B32B 7/12; B32B 37/00

(52) U.S. Cl. CPC B32B 3/30; B32B 37/025; B32B 38/10; B32B 7/12; B32B 2307/536; B32B 2311/005; B32B 2551/00; B32B 2457/12; B32B 2457/20

(57) ABSTRACT

A transfer film having a transfer layer disposed on a support film provided with the concave-convex structure, wherein the transfer layer includes a shape retaining layer and an adhesive layer, both the shape retaining layer and the adhesive layer containing a condensation product of a metal alkoxide, and the support film, the shape retaining layer, and the adhesive layer being disposed in this order.

### TECHNICAL FIELD

This disclosure relates to a transfer film having a transfer layer containing a condensation product of a metal alkoxide disposed on a support film provided with the concave-convex structure. The disclosure also relates to a method of producing a laminate provided with a concave-convex structure prepared by using such transfer film.

### BACKGROUND

Various substrates including glass substrates, metal substrates, and crystalline substrates are recently used for the substrate in a liquid crystal display, solar battery, LED, and the like. The surfaces of these substrates are required to have a functional layer having functions such as anti-static, anti-reflective, anti-staining, light-scattering, power-generating, light-emitting, or other functions required in the intended application. A conventional known method used to form the functional layer is coating a photocurable resin on the substrate. The layer formed by using a photocurable resin, however, suffered from decomposition at a high temperature in excess of 250° C. and yellowing by UV and, therefore, the layer had the problem of incapability of processing at high temperature, insufficient thermal resistance and light resistance in use.

In contrast, glass and ceramics are materials prepared by sintering at a high temperature and, therefore, they are free from decomposition and yellowing at the temperature of several hundred degrees used for processing various substrates. Accordingly, when the functional layer is formed by using such glass or ceramics, the resulting layer can be used and processed in a much wider temperature range than the layer prepared by using a common organic resin. A widely known convenient method of obtaining such a ceramic film is the method commonly known as “sol-gel method” wherein a solution of a metal alkoxide is used as the starting material, and a gel is prepared by chemical reaction such as hydrolysis and polycondensation of the metal alkoxide, and the resulting gel is subjected to a heat treatment to remove the solvent remaining in its interior and improvement of the compactness of the crosslink structure to thereby obtain the glass or ceramics.

More specifically, when the metal alkoxide (starting material) is an alkoxysilane, the glass can be obtained by a heat treatment at approximately several hundred to 1000° C., and formation of concave-convex structure on the glass substrate surface by using this method has been reported (Japanese Patent No. 4079383). A method of forming a fine structure on the surface of the functional layer by using a similar method is also known, and exemplary known such methods include a method wherein a solution containing a silicon alkoxide is coated on a substrate, and the coating is solidified by pressing the coating with a mold (Japanese Patent No. 3750393), and a method wherein a pattern is formed by resist using a resin having siloxane structure provided with UV curability (Japanese Unexamined Patent Publication (Kokai) No. 2006-154037).

On the other hand, since continuous formation of a consistent film on a rigid material such as glass or formation of a consistent layer on a curved surface in forming the functional layer is difficult by the method wherein the solution is coated on a substrate, methods wherein the functional layer is preliminarily formed on a soft substrate such as a film and then transferred onto a transfer layer-receiving object have been proposed (JP '393 and Japanese Unexamined Patent Publication (Kokai) No. 2004-122701).

However, when a functional layer is provided on the substrate by the sol-gel method as described above, there was a problem that realization of stable quality was difficult due to gelation in the solution containing the metal alkoxide. In addition, removal and recovery of a large amount of solvent was necessary to dry and solidify the sol, and there has been another problem in that a large scale environment-friendly installation was necessary for the processing.

In addition, a complicated less-productive step such as pressing of the mold after the sol coating and just before gelation followed by heating the mold for a long time was required when optical properties and surface properties were to be achieved by providing a fine structure on the surface of a layer containing the condensation product of the metal alkoxide. Furthermore, a heat treatment to remove solvent from the gel as well as compaction of the gel was necessary after provision of the concave-convex structure on the surface of the metal alkoxide film by pressing the mold or the like, and there has been a problem that the thus provided structure collapsed in this heat treatment.

In view of the problems as described above, it could be helpful to provide a method of manufacturing a laminate provided with a concave-convex structure on the surface of a material having a high heat resistance by a convenient production process.

### SUMMARY

We thus provide a method of manufacturing a laminate comprising a transfer layer-receiving object and a transfer layer provided with a concave-convex structure disposed on the transfer layer-receiving object.

This method comprises the steps of
first step of preparing a transfer film wherein a transfer layer is disposed on a support film provided with the concave-convex structure, the transfer layer including a shape retaining layer and an adhesive layer, both the shape retaining layer and the adhesive layer containing a condensation product of a metal alkoxide, and the support film, the shape retaining layer, and the adhesive layer being disposed in this order;
second step wherein the transfer film prepared in the first step and the transfer layer-receiving object are brought in contact with each other with the adhesive layer surface of the transfer film facing the transfer layer-receiving object to prepare a laminate including the transfer layer-receiving object and the transfer film, and
third step wherein the support film is removed from the laminate obtained in the second step.

We also provide a transfer film having a transfer layer disposed on a support film provided with the concave-convex structure. The transfer layer includes a shape retaining layer and an adhesive layer, and both the shape retaining layer and the adhesive layer contains a condensation product of a metal alkoxide. The support film, the shape retaining layer, and the adhesive layer are disposed in this order.

We enable production of a highly heat-resistant laminate having a concave-convex structure formed thereon by a convenient process.

### BRIEF DESCRIPTION OF THE DRAWINGS

FIG. 1 is a schematic cross-sectional view of the transfer film.

FIG. 2 is a schematic cross-sectional view showing the thickness of the transfer layer of a transfer film provided with a concave-convex structure on the surface of the support film.

FIG. 3 shows a planer view and a cross-sectional view of the Berkovich tip used to measure the hardness.

FIG. 4 shows a load-penetration depth curve obtained by nanoindentation technique.

FIG. 5 shows a load-penetration depth curve obtained by continuous stiffness measurement technique.

FIG. 6(a) is a schematic cross-sectional view of a laminate provided with the concave-convex structure having a random concave-convex shape transferred thereto. FIG. 6(b) is a schematic cross-sectional view of a laminate provided with the concave-convex structure having a flat area in each of the concave parts and convex parts transferred thereto.

### EXPLANATION OF NUMERALS

1: transfer film
2: support film
3: transfer layer
4: shape retaining layer
5: adhesive layer
6: thickness of the transfer layer
7: thickness of the shape retaining layer
8: thickness of the adhesive layer
9: Berkovich tip
10: initial slope after removal of the load
11: transfer layer-receiving object
12: pitch of the convex structure
13: height of the concave-convex structure

### DETAILED DESCRIPTION

Next, our transfer films and methods are described in detail by referring to the drawings.

### Transfer Film

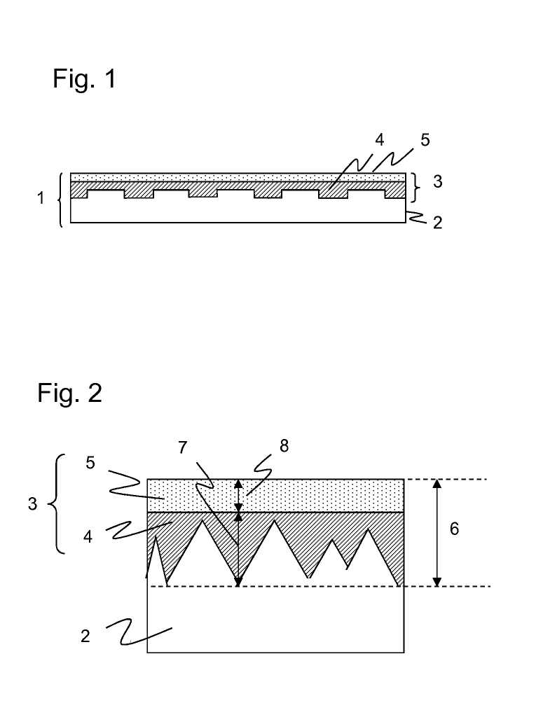

A schematic cross-sectional view of our transfer film is shown in FIG. 1. The transfer film 1 is a transfer film comprising a support film 2 and a transfer layer 3 disposed on the support film 2 and, more specifically, a transfer film comprising the support film 2 having a concave-convex structure provided on the surface which will become in contact with the transfer layer (hereinafter referred to as the support film) and the transfer layer 3 containing a condensation product of a metal alkoxide disposed on the support film 2.

A laminate comprising the transfer layer-receiving object and the transfer film provided with the concave-convex structure disposed thereon can be produced by bringing the transfer film in contact with the transfer layer-receiving object with the transfer layer of the transfer film facing the transfer layer-receiving object, and removing solely the support film from the laminate.

The transfer layer 3 is a laminate of at least 2 layers, namely the shape retaining layer 4 and the adhesive layer 5 both containing the condensation product of a metal alkoxide. The support film 2 provided with the concave-convex structure, the shape retaining layer 4, and the adhesive layer 5 are laminated in this order. The adhesive layer 5 has the function of adhering the shape retaining layer 4 with the transfer layer-receiving object and, therefore, it should constitute the outermost layer. The transfer layer may also contain 3 or more layers as long as the outermost layer is the adhesive layer, and at least one shape retaining layer and at least one adhesive layer are included.

### Transfer Layer

Heat treatment is required to provide the transfer layer with the sufficient heat resistance, and sufficient progress of the crosslinking reaction in the transfer layer is required to retain the concave-convex structure on the surface after the heat treatment. However, when the crosslinking reaction of the transfer layer is promoted to improve shape retainability, hardness of the transfer layer increases with the improvement in shape retainability. On the other hand, when the transfer layer is to be transferred to the transfer layer-receiving object, the transfer layer should follow the structure of the transfer layer-receiving object and the transfer layer should closely adhere to the transfer layer-receiving object to achieve sufficient adhesion, namely, the transfer layer should be soft enough to follow and adhere to the transfer layer-receiving object. As described above, simultaneous realization of contradictory shape retention and softness for the transfer layer has been in demand.

We found that when the transfer layer is functionally divided into the shape retaining layer and the adhesive layer, and each layer contains a condensation product of a metal alkoxide having a high heat resistance, a laminate having a concave-convex structure having a high heat resistance can be produced by a convenient process. The functional division of the transfer layer into the shape retaining layer and the adhesive layer enabled simultaneous realization of the contradictory shape retainability and softness necessary for the transfer layer. Incorporation of the condensation product of a metal alkoxide into both layers enabled provision of the concave-convex structure without the loss of the heat resistance of the transfer layer. Furthermore, incorporation of the condensation product of a metal alkoxide into both layers enabled an increase in the affinity between the shape retaining layer and the adhesive layer, suppression of the peeling between these layers, and use of much thinner adhesive layer enabling provision of finer structure with no adverse effects on the shape retention.

The shape retaining layer is the layer providing the concave-convex structure on the surface of the transfer layer-receiving object by covering the surface of the transfer layer-receiving object after the transfer of the transfer layer onto the transfer layer-receiving object. The shape retaining layer retains its shape when this layer is subjected to a heat treatment at several hundred to 1,000° C. after its transfer onto the transfer layer-receiving object. The shape is regarded as retained when the height of the concave-convex structure after the heat treatment is more than 50% of the height of the concave-convex structure before the heat treatment for the concave-convex structure of the shape retaining layer.

A material exposed to a high temperature generally becomes less viscous, and the uneven surface of the material becomes consistent by surface tension. In other words, even if the material surface was provided with a concave-convex structure, the concave-convex structure will be lost and the surface will become flat at a high temperature. The shape retaining layer is designed so that a crosslinking reaction required to produce a highly heat resistant structure proceeds when the layer is still at a low temperature or in the initial phase of the heat treatment before the decrease of the viscosity, and the shape is thereby retained.

The adhesive layer is required to have a heat resistance equivalent to that of the shape retaining layer since the adhesive layer will be subjected to a heat treatment to improve crosslinking density of the transfer layer. The characteristic feature of the adhesive layer is its high heat resistance without sacrificing the high softness that enables sufficient adhesion to the transfer layer-receiving object, and its details including the design will be described layer.

The transfer layer preferably has a thickness of 0.1 to 10 μm, and more preferably 0.3 to 5 μm. When the transfer layer is thinner than 0.1 μm, depth of the concave-convex structure will be insufficient, and the effect of the concave-convex structure will not be achieved. When the transfer layer is thicker than 10 μm, cracks may be generated in the transfer layer by the shrinkage stress during the curing. The thickness of the transfer layer is, as shown in FIG. 2, the distance 6 between the concave part of the concave-convex structure in the support film and the outermost surface of the transfer film, namely, the thickness of the thickest part of the transfer layer.

The shape retaining layer preferably has a thickness of 0.03 to 9.5 μm, and more preferably 0.1 to 5 μm. When the shape retaining layer is thinner than 0.03 μm, the proportion of the adhesive layer in the transfer layer will be too high, and sufficient shape retaining effects may not be achieved. When the shape retaining layer is thicker than 9.5 μm, the transfer layer will be rigid, and it may suffer from cracks. The thickness of the shape retaining layer is, as shown in FIG. 2, the distance 7 from the concave part of the concave-convex structure of the support film to the adhesive layer, namely, the thickness of the thickest part of the shape retaining layer.

The adhesive layer preferably has a thickness of 0.01 to 2 μm, and more preferably 0.03 to 1 μm. When the adhesive layer is thinner than 0.01 μm, followability and adhesion to the transfer layer-receiving object will be reduced, and transfer of the transfer layer to the transfer layer-receiving object may become reduced. Thickness of the adhesive layer more than 2 μm may result in the reduced shape retainability. In this case, the thickness of the shape retaining layer should be increased to reliably achieve the shape retainability, and this may result in generation of cracks.

Use of a thin adhesive layer enables regulation of the stress in the transfer layer as well as the stress between the adhesive layer and the shape retaining layer, and the effects of preventing peeling between the shape retaining layer and the adhesive layer and as well as suppression of warpage of the transfer layer-receiving object are thereby expected. Use of a thinner adhesive layer also enables a decrease in the thickness of the entire transfer layer. Such a transfer layer is preferable for use in the product requiring a decrease in the thickness and weight. Use of a thinner adhesive layer also enables an increase in the ratio of the shape retaining layer in relation to the entire transfer layer, and the concave-convex structure of the transfer layer will be retained to a higher degree. Preparation of more minute concave-convex structure is also enabled.

The ratio of the shape retaining layer thickness to the adhesive layer thickness is preferably such that the thickness of the shape retaining layer is at least 40%, and more preferably at least 80% of the transfer layer

While the design of the adhesive layer will be described later, the adhesive layer can also be designed to suppress the progress of the crosslinking reaction by introducing a bulky organic functional group to retain the softness of the layer. In this case, when the organic functional group is burned off in the heat treatment at high temperature, the introduced organic functional group will undergo a large contraction due to it bulkiness, and this may invite generation of cracks and peeling from the substrate. However, cracks and film stress can be reduced by using a thinner adhesive layer.

The thickness of the transfer layer, adhesive layer, and the like may be measured by preparing a section of the transfer film by microtome, and imaging the cross section with a scanning electron microscope (hereinafter also abbreviated SEM). The magnification in the measurement is 20,000 when the layer thickness is less than 2 μm, 5,000 when the layer thickness is at least 2 μm and less than 5 μm, and 2,500 when the thickness is at least 5 μm.

### Transfer Layer Material

The shape retaining layer and the adhesive layer constituting the transfer layer both contain the condensation product of a metal alkoxide. The content of the condensation product of the metal alkoxide in each layer is preferably 50 to 99% by mass. When the transfer layer has such a constitution, a transfer film having a transfer layer free from decomposition and yellowing at high temperature can be obtained in contrast to the transfer layer comprising the UV curable resin.

In addition to the condensation product of a metal alkoxide, the transfer layer may further contain a release agent and a leveling agent to improve releasability from the support film and wettability with the support film, or an acrylate resin or the like to improve adhesion with the resin transfer layer-receiving object and crack resistance.

The metal atom constituting the metal alkoxide preferably contains at least one member selected from the group consisting of silicon, aluminum, barium, boron, bismuth, calcium, iron, gallium, germanium, hafnium, indium, lithium, magnesium, niobium, lead, phosphorus, antimony, tin, strontium, tantalum, titanium, vanadium, tungsten, yttrium, zinc, and zirconium.

For example, when the metal atom is silicon, a glass can be obtained by promoting the crosslinking reaction and removing organic substance by heat treatment, and when the metal atom is zinc, indium, tin, or the like, generation of an electroconductive film can be expected when such a metal atom is polymerized and oxidized at an appropriate proportion.

The condensation product of the metal alkoxide constituting the shape retaining layer and the adhesive layer may be either the same or different. Use of the same metal atom, however, is preferable to avoid repellency between the layers and improving the affinity to thereby enable use of thinner layers.

The condensation product of the metal alkoxide is a product having at least 2 consecutive M-O-M bonds comprising one oxygen atom (O) sandwiched by 2 metal atoms (M), and the metal atom may have an organic functional group directly bonded thereto. When the condensation product of the metal alkoxide is the one having an organic functional group directly bonded to the metal atom, the resulting film will have an improved softness. A product well suited for each layer may be obtained by adjusting the proportion of the metal atom having the organic functional group in the condensation product of a metal alkoxide.

The condensation product of a metal alkoxide preferably has a weight average molecular weight as measured by gel permeation chromatography (GPC) calculated in terms of styrene of 500 to 100,000. The weight average molecular weight of less than 500 may have adverse effects on the shape retaining property due to a decrease in the polycondensation speed in forming the transfer layer. On the other hand, when the weight average molecular weight is in excess of 100,000, the viscosity of the solution will be high in forming the shape retaining layer and the adhesive layer. This result in the difficulty of forming the layer having a consistent thickness and filling of the concave-convex structure of the support film.

The condensation product of a metal alkoxide can be prepared by hydrolysis and polycondensation of at least one metal alkoxide represented by Formula (1):

(R2)ₙ-M-(OR1)ₘ₋ₙ (1).

In Formula (1), M represents a metal atom constituting the metal alkoxide, m is an integer representing the valence of the metal atom, n is an integer of 0 to an integer represented by (m−1). R1 is independently one of hydrogen, an alkyl group containing 1 to 10 carbon atoms, an alkenyl group containing 2 to 10 carbon atoms, and an aryl group containing 6 to 15 carbon atoms (when two or more R1 are present, they may be either the same or different). R2 is independently one of hydrogen, an alkyl group containing 1 to 6 carbon atoms, an acyl group containing 1 to 6 carbon atoms, and an aryl group containing 6 to 15 carbon atoms (when two or more R2 are present, they may be either the same or different).

To prevent cracks during storage of the transfer film and the high temperature treatment after the transfer onto the transfer layer-receiving object, the starting material of the condensation product of a metal alkoxide used may preferably contain 5 to 100% by mole of the metal alkoxide wherein n≧1.

In the metal alkoxide represented by Formula (1), the alkyl group, alkenyl group, and aryl group of the R1 may be either a substituted or an unsubstituted group, and R1 may be selected according to the property of the composition.

Examples of the alkyl group include methyl group, ethyl group, n-propyl group, isopropyl group, n-butyl group, t-butyl group, n-hexyl group, n-decyl group, trifluoromethyl group, 3,3,3-trifluoropropyl group, 3-glycidoxy propyl group, 2-(3,4-epoxycyclohexyl) ethyl group, [(3-ethyl-3-oxetanyl)methoxy]propyl group, 3-aminopropyl group, 3-mercaptopropyl group, and 3-isocyanatepropyl group.

Examples of the alkenyl group include vinyl group, 3-acryloxypropyl group, and 3-methacryloxypropyl group.

Examples of the aryl group include phenyl group, tolyl group, p-hydroxyphenyl group, 1-(p-hydroxyphenyl)ethyl group, 2-(p-hydroxyphenyl)ethyl group, 4-hydroxy-5-(p-hydroxyphenylcarbonyloxy)pentyl group, and naphthyl group.

In the metal alkoxide represented by Formula (1), the alkyl group, the acyl group, and the aryl group of R2 may be either a substituted or an unsubstituted group, and R2 may be selected according to the property of the composition. Examples of the alkyl group include methyl group, ethyl group, n-propyl group, isopropyl group, n-butyl group, n-pentyl group, and n-hexyl group, and examples of the acyl group include acetyl group, propynoyl group, butyloyl group, pentanoyl group, and hexanoyl group. Examples of the aryl group include phenyl group, and naphthyl group.

These metal alkoxide may be used alone or in combination of two or more.

Crosslinking density increases with the increase in the crosslinking point of the metal atom in the metal alkoxide, and the increase in the crosslinking density is advantageous for the shape retention. On the other hand, fewer crosslinking points result in the softer layer. The metal alkoxide used in the shape retaining layer is preferably the one wherein n=0 or 1 to increase the crosslinking density. The shape retaining layer may have metal oxide particles or the like added thereto to thereby improve abrasion resistance and hardness.

On the other hand, in the metal alkoxide used in the adhesive layer, use of the one having larger n is preferable to achieve sufficient softness. More specifically, n is preferably at least 1 and up to (m−2). In addition, when the organic functional group R2 is bulky, increased steric hindrance will suppress the crosslinking reaction, and softness of the layer will be maintained for a longer time. This is advantageous for adhesion. Examples of the bulky organic functional group include n-hexyl group, phenyl group, and naphthyl group.

The metal alkoxide represented by Formula (1) exhibits different reactivity depending on the nature of the metal atom M. When M is silicon, reactivity is low, and R1 is preferably methyl group exhibiting high reactivity. When the metal atom M is a highly reactive metal atom such as titanium and aluminum, a reaction may be induced even by the moisture in the air. Therefore, both R1 and R2 are preferably a bulky functional group to reduce reactivity.

For example, when the metal atom M is silicon, Formula (1) represents an organoalkoxysilane. Examples of the organoalkoxysilane include tetrafunctional silanes such as tetramethoxysilane, tetraethoxysilane, tetraacetoxysilane, and tetraphenoxysilane; trifunctional silanes such as methyltrimethoxysilane, methyltriethoxysilane, methyltriisopropoxysilane, methyltri-n-butoxysilane, ethyltrimethoxysilane, ethyltriethoxysilane, ethyltriisopropoxysilane, ethyltri-n-butoxysilane, n-propyltrimethoxysilane, n-propyltriethoxysilane, n-butyltrimethoxysilane, n-butyltriethoxysilane, n-hexyltrimethoxysilane, n-hexyltriethoxysilane, decyltrimethoxysilane, vinyltrimethoxysilane, vinyltriethoxysilane, 3-methacryloxypropyltrimethoxysilane, 3-methacryloxypropyltriethoxysilane, 3-acryloxypropyltrimethoxysilane, phenyltrimethoxysilane, phenyltriethoxysilane, 1-naphthyltrimethoxysilane, 1-naphthyltriethoxysilane, 1-naphthyltri-n-propoxysilane, 2-naphthyltrimethoxysilane, trifluoro methyltrimethoxysilane, trifluoro methyltriethoxysilane, 3,3,3-trifluoropropyltrimethoxysilane, 3-aminopropyltrimethoxysilane, 3-aminoprop-yltriethoxysilane, 3-glycidoxy propyltrimethoxysilane, 3-glycidoxypropyltriethoxysilane, 2-(3,4-epoxycyclohexyl)ethyltrimethoxysilane, and 3-mercaptopropyltriethoxysilane; difunctional silanes such as dimethyldimethoxysilane, dimethyldiethoxysilane, dimethyldiacetoxysilane, di-n-butyldimethoxysilane, and diphenyl dimethoxysilane; and monofunctional silanes such as trimethylmethoxysilane and tri-n-butylethoxysilane.

Of these, those suitable for use in the shape retaining layer include tetramethoxysilane, tetraethoxysilane, methyltrimethoxysilane, and methyltriethoxysilane; and those suitable for use in the adhesive layer include phenyltrimethoxysilane, phenyltriethoxysilane, 1-naphthyltrimethoxysilane, 1-naphthyltriethoxysilane, 1-naphthyltri-n-propoxysilane, and 2-naphthyltrimethoxysilane.

### Crosslinking Auxiliary Agent

To effectively provide the transfer layer that has been transferred to the transfer layer-receiving object with the light and heat resistance, a heat treatment at several hundred degrees (° C.) may be conducted for sufficient promotion of the polycondensation reaction of the metal alkoxide to thereby form a dense crosslink structure, and for burning off the organic functional group bonded to the metal atom to thereby convert the transfer layer into an inorganic material. However, such heat treatment at a high temperature invites a decrease in the viscosity of the transfer layer that results in the collapse of the concave-convex structure despite promotion of the crosslinking reaction of the metal alkoxide. A crosslinking auxiliary agent may be added to the shape retaining layer to suppress such collapse of the structure to suppress such collapse.

The crosslinking auxiliary agent is, for example, a monomer, an oligomer, or a metal chelate having higher valences capable of forming M-O-M bond such as a tetraalkoxysilane, tetramethoxysilane, and the like. Addition of the crosslinking auxiliary agent increases the crosslinking points between the molecules of the metal alkoxide condensation product constituting the transfer layer and, hence, increase in the crosslinking density speed. This suppresses loss of the heat resistance of the transfer layer and, hence, a decrease in the amount of impurities from organic substances and a decrease in the heat resistance. Furthermore, since the crosslinking auxiliary agent is taken into the polymer main chain of the condensation product of a metal alkoxide, the effect of suppressing the shape retaining layer shrinkage with the progress of the crosslinking can be expected.

Examples of the crosslinking auxiliary agent include metal alkoxide monomers such as tetramethoxysilane, tetraalkoxysilane, tetra-n-butoxy titanium, tetra-n-propoxy zirconium, and tetra-n-butoxy zirconium; metal alkoxide oligomers such as cyclic aluminum oxide isopropylate, and cyclic aluminum oxide stearate; metal hydroxides such as tetrahydroxysilane; and metal chelates such as ethyl acetoacetate aluminum diisopropylate, aluminum tris(ethyl acetoacetate), alkyl acetoacetate aluminum diisopropylate, aluminum monoacetylacetonate bis(ethyl acetoacetate), di-isopropoxy bis(acetylacetonate) titanium, propane dioxytitanium bis(ethyl acetoacetate), tributoxy acetonate zirconium, zirconium tributoxy stearate, and tributoxy monoacetonate zirconium.

Of these, use of a tetrafunctional crosslinking auxiliary agent such as tetramethoxysilane or tetrahydroxysilane is preferable to increase hardness of the shape retaining layer and thereby improve shape retention.

When a trifunctional crosslinking auxiliary agent such as aluminum chelate is used, hardness will be low compared to the case using a tetrafunctional crosslinking auxiliary agent. However, reactivity will be higher, and the crosslinking reaction will proceed at a higher rate in shorter time, and the shape retention will be favorably high despite the lower hardness.

Content of the crosslinking auxiliary agent is preferably 0.3 to 20% by mole in relation to the metal atom in the condensation product of a metal alkoxide constituting the transfer layer. When the content is less than 0.3% by mole, the effect of increasing the crosslinking density and crosslinking speed by the crosslinking auxiliary agent will be insufficient, and shape retention will be insufficient. Content in excess of 20% by mole will invite an increase in the viscosity or gelation of the sol of the condensation product of the metal alkoxide constituting the transfer layer, and this results in the difficulty of forming the consistent transfer layer.

### Support Film

The support film preferably has a thickness of 5 to 500 μm, and more preferably 40 to 300 μm. When the support film is thinner than 5 μm, the film may become creased in the transfer of the transfer layer, and there is a risk that the transfer layer-receiving object is not accurately covered. On the other hand, when the thickness is in excess of 500 μm, the support film may become too rigid to follow the transfer layer-receiving object.

The material of the support film is not particularly limited as long as it can endure heating in removal of the solvent from the transfer layer and the transfer onto the transfer layer-receiving object. Examples include polyester resins such as polyethylene terephthalate, polyethylene-2,6-naphthalate, polypropylene terephthalate, and polybutylene terephthalate; polyolefin resins such as polyethylene, polystyrene, polypropylene, polyisobutylene, polybutene, and polymethyl pentene; cyclic polyolefin resins; polyamide resins; polyimide resins; polyether resins; polyester amide resins; polyether ester resins; acrylate resins; polyurethane resins; polycarbonate resins; and polyvinyl chloride resin. In view of simultaneously realizing good coating of the siloxane sol which is the transfer layer and releasability between the transfer layer and the support film, the preferred are polyolefin resin and acrylate resin.

If desired, a resin layer different from the support film may be disposed on the support film to achieve an appropriate surface of the support film. The term “appropriate surface” means that coating adaptability and releasability are simultaneously achieved irrespective of the surface structure since the coating adaptability and the releasability depends on the surface structure.

If desired, the surface of the support film contacting the transfer layer may be treated by coating a base adjusting composition, undercoat composition, or silicone or fluorine release composition, or by sputtering with a noble metal such as gold or platinum to thereby provide the surface with coating adaptability or releasability.

The surface of the support film contacting the transfer layer has a concave-convex structure which is an inversion of the concave-convex structure of the transfer layer transferred to the transfer layer-receiving object. These concave-convex structures may be either a continuous structure or a discretely dispersed structure. The method used to form the concave-convex structure of the support film is not particularly limited, and the structure may be formed by using any known methods such as thermal imprinting, UV imprinting, coating, etching, and the like.

### Transfer Layer-Receiving Object

The transfer layer-receiving object is an inorganic material including metal oxide as its main component, this material is a rigid material capable of withstanding the high temperature of several hundred degrees. Examples of the material used for the transfer layer-receiving object include glass, metal, silicon, sapphire, and the like. The transfer layer-receiving object is not particularly limited for its shape, and preferred is the shape without projections and unevenness to facilitate the coverage of the transfer layer-receiving object by the transfer film.

Next, the method of manufacturing the laminate provided with a concave-convex structure is described.

We provide a method of manufacturing a laminate comprising a transfer layer-receiving object and a transfer film provided with a concave-convex structure disposed on the transfer layer-receiving object. The method comprises the steps of
first step of preparing a transfer film wherein a transfer layer is disposed on a support film provided with the concave-convex structure, the transfer layer including a shape retaining layer and an adhesive layer, both the shape retaining layer and the adhesive layer containing a condensation product of a metal alkoxide, and the support film, the shape retaining layer, and the adhesive layer being disposed in this order;
second step wherein the transfer film prepared in the first step and the transfer layer-receiving object are brought in contact with each other with the adhesive layer surface of the transfer film facing the transfer layer-receiving object to prepare a laminate including the transfer layer-receiving object and the transfer film, and
third step wherein the support film is removed from the laminate obtained in the second step.

### First Step: Preparation of Transfer Film

The transfer film is prepared in the first step. The transfer film may be prepared by coating a sol containing the condensation product of a metal alkoxide on the support film provided with the concave-convex structure on the surface provided with the concave-convex structure, and thereafter drying the coating.

To prepare a transfer layer having an appropriate thickness, the metal alkoxide sol used for the coating (hereinafter referred to as composition of the transfer layer) may be diluted by a solvent. The solvent is not particularly limited as long as it can dissolve the condensation product of a metal alkoxide forming the transfer layer. The solvent, however, is preferably an organic solvent in view of the low risk of repellency on the film. Examples include high boiling point alcohols such as 3-methyl-3-methoxy-1-butanol; glycols such as ethyleneglycol and propylene glycol; ethers such as ethylene glycol monomethyl ether, ethyleneglycol monomethyl ether acetate, propylene glycol monomethyl ether, propylene glycol monoethyl ether, propylene glycol monomethyl ether acetate, propylene glycol monoethyl ether, propylene glycol monopropyl ether, propylene glycol monobutyl ether, diethylether, diisopropyl ether, di-n-butyl ether, diphenyl ether, diethylene glycol dimethyl ether, diethylene glycol diethyl ether, diethylene glycol ethyl methyl ether, and dipropylene glycol dimethyl ether; ketones such as methyl isobutyl ketone, diisopropyl ketone, diisobutyl ketone, cyclopentanone, cyclohexanone, 2-heptanone, and 3-heptanone; amides such as dimethylformamide and dimethyl acetamide; esters such as ethyl acetate, butyl acetate, ethyl acetate, ethyl cellosolve acetate, and 3-methyl-3-methoxy-1-butanol acetate; aromatic or aliphatic hydrocarbons such as toluene, xylene, hexane, cyclohexane, mesitylene, and diisopropylbenzene; and γ-butyrolactone, N-methyl-2-pyrrolidone, and dimethyl sulfoxide.

In view of the solubility and coating adaptability of the siloxane oligomer, a solvent selected from propylene glycol monomethyl ether, propylene glycol monoethyl ether, propylene glycol monomethyl ether acetate, propylene glycol monoethyl ether, diisobutyl ether, di-n-butyl ether, diethylene glycol dimethyl ether, diethylene glycol diethyl ether, diethylene glycol ethyl methyl ether, dipropylene glycol dimethyl ether, methyl isobutyl ketone, diisobutyl ketone, and butyl acetate is preferred.

The method used for the coating of the transfer layer may be adequately selected from die coating, gravure coating, roll coating, spin coating, reverse coating, bar coating, screen coating, blade coating, air knife coating, dip coating, curtain coating, and the like. The method used for a laminated transfer layer is not particularly limited, and exemplary methods include a method wherein a metal alkoxide sol to form the shape retaining layer (hereinafter referred to as the composition of the shape retaining layer) and a metal alkoxide sol to form the adhesive layer (hereinafter referred to as the composition of the adhesive layer) are coated on the support film in this order; a method wherein two or more metal alkoxide sols are simultaneously coated by curtain coating or die coating; a method wherein the layer is separated into 2 layers by phase separation; and the like.

After forming the transfer layer, the solvent is removed by heating, exposure to a reduced pressure environment or the like. When the solvent is removed by heating, the layer is preferably heated to a temperature of at least 20° C. and up to 180° C. A much longer period may be required when heated to a temperature of less than 20° C., while heating to a temperature in excess of 180° C. may result in the generation of cracks by the loss of softness of the transfer film by the crosslinking of the siloxane by heating and insufficient transfer of the layer to the transfer layer-receiving object.

The reduced pressure condition used for removal of the solvent may be adequately selected in the range not resulting in the collapse of the structure of the transfer film, and pressure reduction to at least 10 kPa is preferable. The solvent may also be removed by conducing the heating simultaneously with the exposure to reduced pressure.

The crosslinking reaction of the condensation product of the metal alkoxide proceeds through hydrolysis and dehydration condensation and, therefore, the water content produced in the dehydration condensation may be removed by heating to thereby promote the crosslinking, or by providing sufficient time for the progress of the crosslinking reaction in transfer layer by aging.

### Second Step: Preparation of the Laminate

The transfer film prepared in the first step is brought in contact with the transfer layer-receiving object so that the adhesive layer surface faces the transfer layer-receiving object to obtain a laminate including the transfer layer-receiving object and the transfer film.

Before bringing the adhesive layer surface of the transfer film in contact with the transfer layer-receiving object, the adhesive layer may be activated to improve adhesion of the transfer layer-receiving object and the transfer layer. Activation of the adhesive layer can be accomplished by an increase of hydroxyl groups to increase the bonding point of the adhesive layer and the transfer layer-receiving object. This may be accomplished, for example, by plasma treatment, UV treatment, corona treatment, ozone treatment, or various other activation treatments. In the transfer, the pressure may be applied, for example, by using a nip roll, press, or other non-limiting means.

For adhesion of the transfer layer with the transfer layer-receiving object, pressure is preferably applied to the laminate including the transfer layer-receiving object and the transfer film, and this preferably is 1 kPa to 50 MPa. The pressure of less than 1 kPa may result in the transfer defects, while the pressure in excess of 50 MPa may result in the collapse of the concave-convex structure of the transfer film or breakage of the transfer layer-receiving object.

In applying pressure, a cushioning material may be placed between the support film of the laminate and the pressure plate, pressure roll, or the like. Use of the cushioning material allows highly accurate transfer of the transfer layer without trapping air and the like. Exemplary cushioning materials include fluororubber, silicone rubber, ethylene propylene rubber, isobutylene isoprene rubber, and acrylonitrile butadiene rubber. For the sufficient adhesion of the transfer layer to the transfer layer-receiving object, not only the pressure but also the heat may be applied to the laminate.

### Third Step: Removal of the Support Film

The support film is removed from the laminate obtained in the second step to obtain a laminate of the transfer layer-receiving object and the transfer layer. Removal of the support film may be conducted either before or after heat treatment of the laminate provided with a concave-convex structure as described below. When the support film is removed before the heat treatment, the pressure is applied to the laminate as described above, and the temperature is reduced to a temperature not exceeding the temperature used in the pressure application, and only the support film is removed. This results in peeling of the support film at the boundary between the shape retaining layer and the support film, and only the shape retaining layer remains on the transfer layer-receiving object.

On the other hand, when the support film is removed after heat treatment, the support film may become lost or pulverized by burning in the heat treatment. In such a case, the residue of the support film may be removed by washing the surface or by blowing with air. When the support film is present after the heat treatment as the support film in a laminate containing a transfer layer-receiving object, a transfer layer, and a support film, the temperature is reduced to a temperature not exceeding the temperature used in the heat treatment, and only the support film is removed.

### Hardness of the Shape Retaining Layer and the Adhesive Layer

The shape retaining layer constituting the transfer layer preferably has a hardness of 0.1 to 2.0 GPa, while the preferable hardness of the adhesive layer is at least 0.01 GPa and less than 0.1 GPa. The hardness as used herein is Meyer hardness which is measured by penetrating Berkovich tip having a triangular pyramid shape to the depth corresponding to the thickness of the transfer layer. The specific procedure used for the measurement will be described later.

When the hardness of the shape retaining layer is less than 0.1 GPa, the structure may become collapsed in the heat treatment, while physical properties in the case of the hardness in excess of 2.0 GPa will be too different from those of the adhesive layer, and such difference may invite peeling at the boundary with the adhesive layer and crack generation. The hardness of the shape retaining layer is more preferably 0.2 to 1.5 GPa, and still more preferably 0.4 to 1.0 GPa.

Use of the adhesive layer having a hardness of less than 0.01 GPa may invite change in the thickness by being crushed in the pressing of the transfer film onto the transfer layer-receiving object, namely, loss of the function as an adhesive layer. When the adhesive layer has a hardness of at least 0.1 GPa, there is some risk that the surface of the adhesive layer will not be capable of sufficiently following transfer layer-receiving object. This may result in the insufficient adhesion and, hence, decrease in the transfer in the pressing of the transfer film onto the transfer layer-receiving object. The hardness of the adhesive layer is more preferably 0.01 to 0.07 GPa, and still more preferably 0.02 to 0.05 GPa.

The hardness of the shape retaining layer and the adhesive layer can be adjusted by the type of the substituent of the metal alkoxide, initial degree of polymerization, extent of the progress and degree of crosslinking of the polycondensation, and the like. It has been known that a harder layer is formed with the higher degree of the progress of the metal alkoxide polycondensation due to the formation of the denser crosslink structure of the M-O-M bond. Accordingly, in the adhesive layer, use of a metal alkoxide having a bulky organic moiety for the starting material is preferable in view of reducing the degree of the progress of the crosslinking reaction. On the other hand, in the case of the shape retaining layer, treatment of the shape retaining layer, aging, and oxidization at higher temperature is preferable for promoting the crosslinking reaction since higher hardness is advantageous for improving the shape retention. Addition of a crosslinking auxiliary agent to the shape retaining layer is also effective to increase the hardness.

The hardness, namely, Meyer hardness is measured for each of the shape retaining layer and the adhesive layer by forming each layer to a thickness of 1 μm as a monolayer on a glass substrate, heating to 120° C. for 1 hour, measuring the hardness by nanoindentation technique, and depicting a load-penetration depth curve to calculate the hardness.

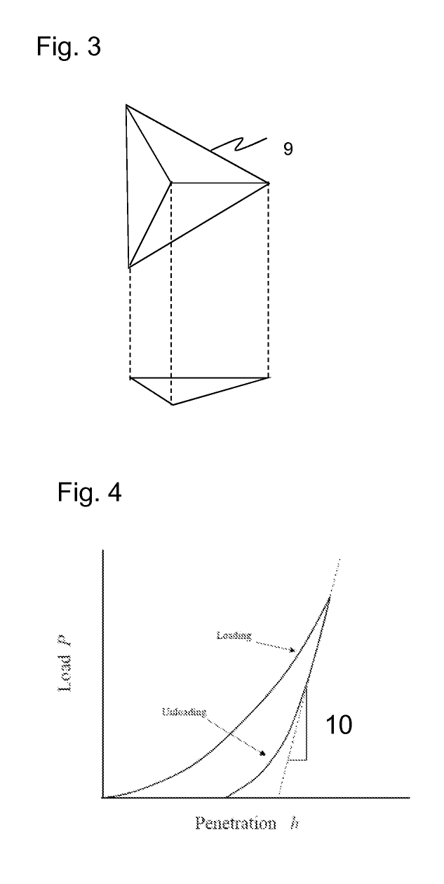

More specifically, a regular triangular pyramid diamond tip having an edge interval of 115°, namely, Berkovich tip 9 (FIG. 3) is pressed into the layer containing the condensation product of a metal alkoxide placed on the glass substrate to the depth equal to the thickness of the transfer layer, and test of placing and removing the load is conducted to depict the load-penetration depth curve (FIG. 4). In this load-penetration depth curve, the load at the penetration point P is divided by the projection area A of the tip obtained by Oliver-Pharr approximation to calculate the hardness H as shown in the following equations:

H=P/A

A=ηkh_{c}.

In this equation, H represents hardness, P represents load, A represents contact projection area, η represents correction coefficient of the Berkovich tip end, and k represents a coefficient determined by the geometry of the tip, which in Berkovich tip is 24.56. η is a parameter which corrects the deviation of the measurement caused by the change in shape through abrasion or the like at the tip end. In the actual measurement, after the measurement of the measurement sample as described above, the standard sample having a known modulus is measured by indentation technique, and the value of η is determined from the values of the resulting modulus and known modulus. h_{c} is effective contact depth which is represented by the following equation:

h_{c}=h−εP/(dP/dh).

In this equation, h is the total displacement measured, and dP/dh is the initial slope 10 when the load is removed in the load-penetration depth curve as shown in FIG. 4. ε is the constant determined by the geometry of the tip, which in Berkovich tip is 0.75.

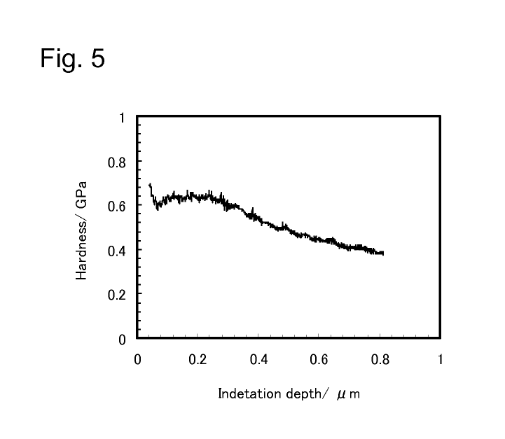

In this measurement, the measurement is conducted by a continuous stiffness measurement technique wherein minute vibration is applied to the tip in the penetration test, and the response amplitude and phase difference in relation to the vibration are obtained as a function of time, and load-penetration depth curve (FIG. 5) is thereby obtained. Since the hardness corresponding to the penetration depth is affected by the hardness of the glass substrate (the support) when the penetration depth is large, the average of the hardness of the area wherein the value of [the penetration depth/thickness of the transfer layer] is 0 to 0.125 was used for the hardness of the transfer layer.

Concave-Convex Shape on the Laminate Provided with the Concave-Convex Structure

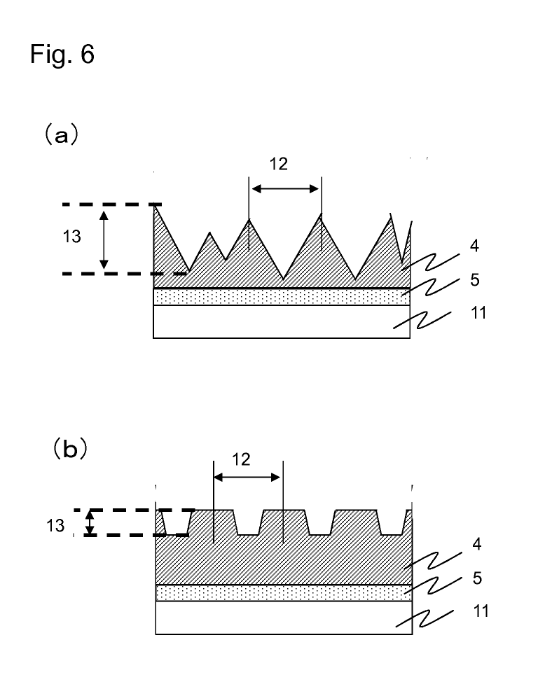

In the transfer layer transferred from the transfer film to the transfer layer-receiving object, the representative pitch of the convex parts of the concave-convex structure is preferably 0.01 to 10 μm, and more preferably 0.1 to 8 μm. When the representative pitch is less than 0.01 μm, foreign objects may be trapped between the convex parts, and the desired structure may not be achieved. When the representative pitch is in excess of 10 μm, the density of the concave-convex structure will be low, and the intended merits of providing the concave-convex structure may not be fully achieved. The pitch is a horizontal distance 12 between the points of local maximum height in the two adjacent convex parts in the support film as shown in FIG. 6(a). When the top of the convex part is flat as shown in FIG. 6(b), the pitch is the horizontal distance 12 between the centers of the flat areas. The representative pitch of the concave-convex structure of the transfer layer as used herein is the pitch of repetitive structure when the concave-convex structure is geometric structure, and the average pitch of 10 arbitrarily chosen points when the concave-convex structure is a random structure.

The representative height of the concave-convex structure is preferably 0.005 to 5 μm, and more preferably 0.01 to 3 μm. The representative height of less than 0.005 μm may result in the loss of the effects of the concave-convex structure. The representative height of more than 5 μm may result in the collapse of the structure by shrinkage during curing or difficulty in the release from the support film. The concave-convex structure is the distance 13 between the adjacent local maximum point of the convex part and the local minimum point of the concave part as shown in FIG. 6(a). When the top of the convex part or the bottom of the concave part is flat as shown in FIG. 6(b), the distance 13 may be the distance between the flat surfaces. The representative height of the concave-convex structure as used herein may be the average height of 10 arbitrarily chosen points. The measurement of the pitch and the height is conducted by a laser microscope when they are at least 1 μm, and by an AFM when they are less than 1 μm.

Heat Treatment of the Laminate Provided with the Concave-Convex Structure

After transfer of the transfer layer to the transfer layer-receiving object, a heat treatment may be conducted to facilitate crosslinking of the condensation product of the metal alkoxide to thereby obtain an oxide film having a denser crosslinked structure. The heat treatment temperature may be adequately selected depending on the heat resistance, chemical resistance, reliability, electroconductive, and the like requirement of the laminate.

For example, the heat treatment temperature when a glass having a concave-convex structure is produced by transferring a siloxane material wherein the metal atom constituting the metal alkoxide is silicon to the inorganic material such as a glass plate is preferably 150 to 1,200° C., more preferably 180 to 800° C., and most preferably 200 to 400° C. When the heat treatment is conducted at less than 150° C., the crosslinking reaction will not be sufficiently promoted, and this may result in the insufficient glassification or decrease in the heat resistance. On the other hand, the heat treatment at a temperature higher than 1,200° C. may result in the cracks or collapse of the concave-convex structure.

In the meanwhile, when the film comprising a siloxane is used as an etching resist film by transferring the film comprising the siloxane onto an inorganic material at low etching rate or a transfer layer-receiving object comprising a crystalline material, the etching rate of the transfer layer should be lower than the transfer layer-receiving object. For this purpose, the organic component in the transfer layer may be burned off to efficiently prepare a compact silicon dioxide film, and the heat treatment temperature is preferably 600 to 1,200° C. When the heat treatment temperature is less than 600° C., the transfer layer may not become sufficiently compact, and the film may not be usable for the etching resist film. A heat treatment temperature in excess of 1,200° C. may invite cracks in the transfer layer. The collapse of the concave-convex structure by heat may also be prevented by conducting prebaking before the heat treatment at a temperature lower than the heat treatment temperature.

Application of the Laminate Provided with the Concave-Convex Structure

The thus obtained laminate provided with the concave-convex structure has a highly heat-resistant concave-convex structure and, therefore, it can be used as an anti-reflection plate or a light scattering plate, which are expected to be used in high temperature environment. When the metal of the metal alkoxide is silicon, the laminate can be used as a resist film in etching and, therefore, the laminate can be used in producing a sapphire substrate provided with a pattern contributing to improvement in the photoextraction efficiency of an LED. The laminate may also be used as a member of a solar battery panel or the like since the laminate can be provided with the concave-convex structure having a photocatalytic property or electroconductivity by adjusting the metal type and mixing ratio.

### EXAMPLES

Next, our transfer films and methods are described in detail by referring to the Examples, which by no means limit the scope of this disclosure.

### (1) Preparation of the Transfer Film

The composition for the shape retaining layer was coated on the support film (50 mm×50 mm) by using a spin coater Model No. 1H-DX2 manufactured by MIKASA Co., Ltd. The coating composition for the adhesive layer was then coated on the resulting shape retaining layer to obtain the transfer film.

### (2) Measurement of Thickness of the Transfer Layer and the Adhesive Layer

The transfer film was dissected by using a rotary microtome Model RMS manufactured by Nihon Microtome Laboratory, Inc., and the cross section was observed by miniSEM Model No. ABT-32 manufactured by TOPCON Corporation to measure the thickness of the transfer layer and the adhesive layer. The magnification in the measurement was 20,000 when the thickness of these layers was less than 2 μm, 5,000 when the thickness was at least 2 μm and less than 5 μm, and 2,500 when the thickness was at least 5 μm.

### (3) Measurement of the Film Hardness

### (3-1) Preparation of the Sample

In measuring the hardness of the shape retaining layer, the condensation product of a metal alkoxide for the formation of the shape retaining layer was coated on the glass substrate for hardness measurement (no-alkali glass EAGLE2000 (30 mm×30 mm×thickness 0.63 mm) manufactured by Corning Japan) to form a film containing the condensation product of a metal alkoxide having a thickness of 1 μm, and the coated glass substrate was heated at 120° C. for 1 hour to prepare the measurement sample.

In measuring the hardness of the adhesive layer, the measurement sample was prepared by repeating the shape retaining layer except that the condensation product of a metal alkoxide was the one for forming the adhesive layer.

### (3-2) Measurement Conditions

The transfer film was measured under the following conditions to depict a load-penetration depth curve:
System used for the measurement: ultra-microhardness tester Nano Indenter XP manufactured by MTS Systems Corp.
Measurement method: nanoindentation technique, continuous stiffness measurement technique
Tip used: diamond regular triangular pyramid tip (Berkovich tip)
Measurement atmosphere: 25° C., atmosphere.

### (3-3) Evaluation of Film Hardness

The hardness corresponding to the penetration depth was calculated from the load-penetration depth curve obtained for the conditions as described above, and a hardness-penetration depth curve was prepared. Average of the hardness data in the area where the penetration depth/film thickness was 0 to 0.125 in the hardness-penetration depth curve was used for the film hardness.

### (4) Evaluation of the Transfer

### (4-1) Preparation of the Transfer Layer-Receiving Object

After blowing the dust off the surface of the transfer layer-receiving object, the transfer layer-receiving object was washed twice while being immersed in pure water by using Three frequency ultrasonic washing machine Model No. VS-100III manufactured by AS ONE Corporation at 45 kHz for 10 minutes, and the transfer layer-receiving object was thereafter surface-treated with plasma at 15000 VAC for 5 minutes by using a Desktop vacuum plasma apparatus manufactured by SAKIGAKE-Semiconductor Co., Ltd.

### (4-2) Transfer Method

The surface on the transfer layer of the transfer film (size, 30 mm×30 mm) was brought into contact with the transfer layer-receiving object prepared in (4-1), and “KINYO BOARD” (registered trademark) Model No. F200 manufactured by Kinyosha Co., Ltd. was disposed on the surface of the transfer film on the side of the support film as a cushioning material. After applying a pressure of 1.38 MPa for 10 seconds at a press temperature of 20° C., the support film was peeled off at room temperature.

### (4-3) Evaluation of Transfer Area Rate

The rate of the area of the laminate (the laminate which is the one having the largest transfer area in the 3 laminates prepared by repeating the procedure under the condition of (4-2) for 3 times) in relation to 100% of the transfer film (size, 30 mm×30 mm) was used for the transfer area rate. The transfer property was evaluated by the following criteria:
4: transfer area rate of at least 90%
3: transfer area rate of at least 50% and less than 90%
2: transfer area rate of at least 10% and less than 50%
1: transfer area rate of less than 10%.

### (5) Evaluation of Shape Retention

The laminate provided with a concave-convex structure obtained by transferring the transfer layer was subjected to a heat treatment for 1 hour on Economy Hot Plate Model No. EHP-250N manufactured by AS ONE Corporation set at 200° C., and the height of the concave-convex structure was measured before and after the heat treatment. The shape retention was evaluated by using a shape retention rate which is the ratio of the height of the concave-convex structure after the heat treatment in relation to 100% of the height of the concave-convex structure before the heat treatment. The shape retention was evaluated by the following criteria:
4: shape retention rate of at least 90%
3: shape retention rate of at least 50% and less than 90%
2: shape retention rate of at least 10% and less than 50%
1: shape retention rate of less than 10%.

The observation and the measurement were conducted by using laser microscope Model No. VK9700 manufactured by KEYENCE Corporation when the structure size was at least 1 μm, and atomic force microscope Model No. Dimension ICON manufactured by Bruker AXS K.K. when the structure size was less than 1 μm.

### Example 1

### Step of Forming the Support Film

A concave-convex structure was provided on one surface of “ZEONOR” (registered trademark) film No. ZF14 (a cyclic polyolefin resin) having a thickness of 60 μm manufactured by Zeon Corporation by thermal imprinting to prepare the support film. Thermal imprinting was conducted by using a prism-shaped nickel electrocasting mold having a pitch of 5 μm and a height 2.0 μm, and the “ZEONOR” (registered trademark) film was pressed onto the mold that had been heated to 180° C. at 2.0 MPa for 30 seconds. The film was then released to obtain the support film.

### Step of Preparing the Transfer Film

As a composition for the shape retaining layer, OCNL505 No. 14000 (condensation product of a metal alkoxide; composition, methylsiloxane polymer) manufactured by Tokyo Ohka Kogyo Co., Ltd. was coated on the surface of the support film having the concave-convex structure provided thereon by spin coating under the condition of 500 rpm. The coating was cured at 120° C. for 1 hour to form the shape retaining layer. As the composition of the adhesive layer, a 10% by mass solution of polyphenylsilsesquioxane SR-23 (condensation product of a metal alkoxide; composition, phenylsiloxane polymer) manufactured by Konishi Chemical Inc. Co., Ltd. in 1-propoxy 2-propanol (hereinafter referred to as PGPE) was coated on the resulting shape retaining layer by spin coating under the condition of 5,000 rpm. The coating was dried at 90° C. for 1 hour to remove the solvent, and obtain an adhesive layer.

### Transfer Step

No-alkali glass EAGLE2000 (30 mm×30 mm×0.63 mm) manufactured by Corning Japan was prepared for the transfer layer-receiving object. The transfer film was brought into contact with the transfer layer-receiving object with the adhesive layer surface facing with the transfer layer-receiving object, and pressed in 2 ton vacuum heater press Model NO. MKP-150TV-WH manufactured by Mikado Technos Co., Ltd. at 20° C. and 1 MPa for 10 seconds to prepare a laminate comprising the transfer layer-receiving object and the transfer film.

### Step of Removing the Support Film

After freeing the pressure, only the support film of the transfer film was removed by peeling to obtain the laminate provided with the concave-convex structure.

### Evaluation of Transfer and Shape Retention Rate

The resulting laminate provided with the concave-convex structure was evaluated for its transfer area rate and shape retention according to the procedures of the (4) and (5) as described above.

### Example 2

To increase the thickness of the shape retaining layer and the adhesive layer compared to Example 1, the laminate provided with the concave-convex structure was formed by repeating the procedure of Example 1 except for some changes in the conditions used in forming the transfer layer. The composition for the shape retaining layer was OCNL505 No. 14000 (condensation product of a metal alkoxide; composition, methylsiloxane polymer) manufactured by Tokyo Ohka Kogyo Co., Ltd., and this composition was coated by spin coating under the condition of 500 rpm followed by preliminary drying at 90° C. for 1 minute. The composition was again coated by spin coating under the condition of 3,000 rpm followed by curing at 120° C. for 1 hour to form the shape retaining layer. The composition of the adhesive layer was a 5% by mass solution of polyphenylsilsesquioxane SR-23 (condensation product of a metal alkoxide; composition, phenylsiloxane polymer) manufactured by Konishi Chemical Inc. Co., Ltd. in PGPE, and this composition was coated by spin coating under the condition of 500 rpm. The coating was dried at 90° C. for 1 hour to remove the solvent and obtain the adhesive layer.

### Example 3

To further increase the thickness of the shape retaining layer and the adhesive layer compared to Example 1, the laminate provided with the concave-convex structure was formed by repeating the procedure of Example 2 except for some changes in the conditions used in forming the transfer layer. The composition for the shape retaining layer was OCNL505 No. 14000 (condensation product of a metal alkoxide; composition, methylsiloxane polymer) manufactured by Tokyo Ohka Kogyo Co., Ltd., and this composition was coated by spin coating under the condition of 500 rpm followed by preliminary drying at 90° C. for 1 minute. The composition was again coated by spin coating under the condition of 500 rpm followed by curing at 120° C. for 1 hour to form the shape retaining layer. The composition of the adhesive layer was a 30% by mass solution of polyphenylsilsesquioxane SR-23 (condensation product of a metal alkoxide; composition, phenylsiloxane polymer) manufactured by Konishi Chemical Inc. Co., Ltd. in PGPE, and this composition was coated by spin coating under the condition of 500 rpm. The coating was dried at 90° C. for 1 hour to remove the solvent and obtain the adhesive layer.

### Example 4

A laminate provided with a concave-convex structure was obtained by repeating the procedure of Example 1 except that the concave-convex structure on the surface was provided by using a support film having the structure of discretely dispersed spheroids having a width of the convex part of 0.25 μm, a height of the convex part of 0.3 μm, and a pitch of the convex part of 0.3 μm (hereinafter referred to as “moth-eye patterns”), and the condition used in coating the transfer layer was changed to reduce the thickness of the shape retaining layer and the adhesive layer compared to Example 1. The composition of the shape retaining layer was a dilution of OCNL505 No. 14000 (condensation product of a metal alkoxide; composition, methylsiloxane polymer) manufactured by Tokyo Ohka Kogyo Co., Ltd. in PGPE at a solid concentration of 1%, and this composition was coated under the condition of spin coating at 1,500 rpm. The composition of the adhesive layer was a 10% by mass solution of polyphenylsilsesquioxane SR-23 (condensation product of a metal alkoxide; composition, phenylsiloxane polymer) manufactured by Konishi Chemical Inc. Co., Ltd. in PGPE, and this composition was coated under the condition of spin coating at 5,000 rpm.

### Example 5

A laminate provided with a concave-convex structure was obtained by repeating the procedure of Example 1 except that the concave-convex structure on the surface was provided by using a support film prepared by using a mold having the pattern of dispersed columnar dots each having a diameter of 1.7 μm, a pitch of 4.0 μm, and a depth of 0.7 μm, and the condition used in coating the transfer layer was changed to reduce the thickness of the shape retaining layer and the adhesive layer compared to Example 1. The composition of the shape retaining layer was a dilution of OCNL505 No. 14000 (condensation product of a metal alkoxide; composition, methylsiloxane polymer) manufactured by Tokyo Ohka Kogyo Co., Ltd. in PGPE at a solid concentration of 1%, and this composition was coated under the condition of spin coating at 1,500 rpm. The composition of the adhesive layer was a 1% by mass solution of polyphenylsilsesquioxane SR-23 (condensation product of a metal alkoxide; composition, phenylsiloxane polymer) manufactured by Konishi Chemical Inc. Co., Ltd. in PGPE, and this composition was coated under the condition of spin coating at 3,000 rpm.

### Example 6

A laminate provided with a concave-convex structure was obtained by repeating the procedure of Example 1 except that the transfer layer-receiving object was changed to a silicon wafer.

### Example 7

A laminate provided with a concave-convex structure was obtained by repeating the procedure of Example 1 except that the transfer layer-receiving object was a sapphire substrate, and the coating conditions used for the coating of the transfer layer was changed. The composition of the shape retaining layer was OCNL505 No. 14000 (condensation product of a metal alkoxide; composition, methylsiloxane polymer) manufactured by Tokyo Ohka Kogyo Co., Ltd., and the composition was coated under the condition of spin coating at 1,000 rpm. The composition of the adhesive layer was a 5% by mass solution of polyphenylsilsesquioxane SR-23 (condensation product of a metal alkoxide; composition, phenylsiloxane polymer) manufactured by Konishi Chemical Inc. Co., Ltd. in PGPE, and the composition was coated under the condition of spin coating at 1,500 rpm.

### Example 8

A laminate provided with a concave-convex structure was obtained by repeating the procedure of Example 1 except that the composition for the adhesive layer was a 10% by mass solution of polymethylphenylsilsesquioxane SR-3321 (condensation product of a metal alkoxide; composition, methylphenylsiloxane polymer) manufactured by Konishi Chemical Inc. Co., Ltd. in PGPE, and the composition was coated by spin coating under the condition of 5,000 rpm.

### Example 9

A laminate provided with a concave-convex structure was obtained by repeating the procedure of Example 1 except that the composition for the adhesive layer was a 8% by mass solution of polymethylsilsesquioxane SR-13 (condensation product of a metal alkoxide; composition, methylsiloxane polymer) manufactured by Konishi Chemical Inc. Co., Ltd. in PGPE, and the composition was coated by spin coating under the condition of 5,000 rpm, and the transfer layer-receiving object was a silicon wafer.

### Example 10

A laminate provided with a concave-convex structure was obtained by repeating the procedure of Example 1 except that the composition of the shape retaining layer was a 20% by mass solution of polymethylsilsesquioxane SR-13 (condensation product of a metal alkoxide; composition, methylsiloxane polymer) manufactured by Konishi Chemical Inc. Co., Ltd. in PGPE having aluminum chelate D (aluminum monoacetyl acetonate bis(ethyl acetoacetate) solution) manufactured by Kawaken Fine Chemicals Co., Ltd. added as the crosslinking auxiliary agent so that the molar ratio of the silicon atom in the SR-13 to the aluminum atom in the metal chelate (aluminum chelate D) was 0.4%, and composition was coated under the condition of the spin coating at 1,500 rpm; and the composition of the adhesive layer was a 25% by mass solution of polymethylsilsesquioxane SR-13 (condensation product of a metal alkoxide; composition, methylsiloxane polymer) manufactured by Konishi Chemical Inc. Co., Ltd. in PGPE, and the composition was coated under the condition of the spin coating at 500 rpm.

### Example 11

A laminate provided with a concave-convex structure was obtained by repeating the procedure of Example 10 except that the aluminum chelate D used for the crosslinking auxiliary agent was added at an amount so that molar ratio of the silicon atom in the SR-13 to the aluminum atom in the aluminum chelate D was 20%, and the composition was coated under the conditions of spin coating at 500 rpm; and the composition of the adhesive layer was a 5% by mass solution of polymethylsilsesquioxane SR-13 (condensation product of a metal alkoxide; composition, methylsiloxane polymer) manufactured by Konishi Chemical Inc. Co., Ltd. in PGPE, and the composition was coated under the conditions of spin coating at 1,000 rpm.

### Example 12

A laminate provided with a concave-convex structure was obtained by repeating the procedure of Example 10 except that the surface concave-convex structure had a moth-eye pattern, the concentration of the shape retaining layer was 10% by mass, the adhesive layer was formed by using the concentration of 10% by mass, and the coating was conducted under the conditions of spin coating at 3,000 rpm.

### Example 13

A laminate provided with a concave-convex structure was obtained by repeating the procedure of Example 10 except that the crosslinking auxiliary agent added to the shape retaining layer was ZAA3 (monobutoxy triacetonate zirconium) manufactured by Nippon Soda Co., Ltd., the molar ratio of the silicon atom in the SR-13 to the zirconium atom in the ZAA3 was 2%, and the condition used in the coating was changed to 500 rpm; and the concentration of the adhesive layer was 10% by mass, and the coating condition was the spin coating at 1500 rpm.

### Example 14

A laminate provided with a concave-convex structure was obtained by repeating the procedure of Example 10 except that the crosslinking auxiliary agent added to the shape retaining layer was KBM-04 manufactured by Shin-Etsu Chemical Co., Ltd., the molar ratio of silicon atom in the SR-13 to the silicon atom in the KBM-04 was 20%, and the coating condition was spin coating at 800 rpm; and concentration of the adhesive layer was 10% by mass and the coating condition was spin coating at 3,000 rpm.

### Example 15

A laminate provided with a concave-convex structure was obtained by repeating the procedure of Example 14 except that the crosslinking auxiliary agent added to the shape retaining layer was changed to tetrahydroxysilane prepared by hydrolysis of KBM-04 manufactured by Shin-Etsu Chemical Co., Ltd.

### Example 16

A laminate provided with a concave-convex structure was obtained by repeating the procedure of Example 4 except that the composition of the shape retaining layer was a 10% by mass solution of a tetrafunctional siloxane polymer which is the hydrolysis and condensation product of KBM-04 manufactured by Shin-Etsu Chemical Co., Ltd. in propylene glycol monomethyl ether acetate, and the composition was coated under the condition of spin coating at 1,500 rpm, and cured at 120° C. for 1 hour to obtain the shape retaining layer. The composition of the adhesive layer was a 10% by mass solution of polymethylsilsesquioxane SR-13 (condensation product of a metal alkoxide; composition, methylsiloxane polymer) manufactured by Konishi Chemical Inc. Co., Ltd. in PGPE, and the composition was coated under the condition of spin coating at 5,000 rpm, and dried at 90° C. for 1 hour to obtain the adhesive layer.

### Example 17

A laminate provided with a concave-convex structure was obtained by repeating the procedure of Example 10 except that the composition of the shape retaining layer was a 20% by mass solution of copolymerization product of methylsiloxane and titania in PGPE, and the composition was coated under the condition of spin coating at 2,000 rpm; and the composition of the adhesive layer was at a concentration of 5% by mass, and the coating was conducted under the condition of 500 rpm.

The methyl siloxane-titania copolymerization product was prepared by hydrolysis and polycondensing KBE-13 manufactured by Shin-Etsu Chemical Co., Ltd. in water-methanol mixed solvent, and adding thereto titanium (IV) tetrabutoxide and ethyl 3-oxobutanoate manufactured by Wako Pure Chemical Industries, Ltd. which had been hydrolyzed and chelated in ethanol. The preparation was conducted so that metal molar ratio in the methylsiloxane-titania copolymerization product was Si/Ti=90/10.

### Example 18

A laminate provided with a concave-convex structure was obtained by repeating the procedure of Example 17 except that the composition for the shape retaining layer had a metal molar rate Si/Ti of 10/90 and the coating condition was spin coating at 500 rpm; and the concentration of the adhesive layer was 10% by mass and the coating condition was spin coating at 3,000 rpm.

### Comparative Example 1

OCNL505 No. 14000 (condensation product of a metal alkoxide; composition, methylsiloxane polymer) manufactured by Tokyo Ohka Kogyo Co., Ltd. was coated on the support film prepared by the procedure described in Example 1 under the same conditions as Example 2, and the coating was dried at 120° C. to obtain the transfer film having a monolayer transfer layer. Although transfer of the resulting transfer film onto the no-alkali glass EAGLE2000 manufactured by Corning Japan was attempted by following the procedure of Example 1, the transfer could not be completed due to insufficient adhesion of the transfer layer onto the transfer layer-receiving object.

### Comparative Example 2

A transfer film was formed by repeating the procedure of Comparative Example 1 except that the composition of the transfer layer was a 20% by mass solution of polymethylsilsesquioxane SR-13 (condensation product of a metal alkoxide; composition, methylsiloxane polymer) manufactured by Konishi Chemical Inc. Co., Ltd. in PGPE, and this composition was coated by spin coating under the condition of 500 rpm. By using the resulting transfer film, the laminate provided with the concave-convex structure was formed by repeating the procedure of Example 1.

### Comparative Example 3

The transfer film was obtained by repeating the procedure of Example 1 except that the composition of the shape retaining layer was OCNL505 No. 14000 (condensation product of a metal alkoxide; composition, methylsiloxane polymer) manufactured by Tokyo Ohka Kogyo Co., Ltd., and the composition was coated by repeating the procedure of Comparative Example 1, and the composition of the adhesive layer coated was an epoxy adhesive (Araldite Rapid) with the proviso that the adhesive layer was coated by a spatula due to the extremely high viscosity of the adhesive, and the adhesive layer was cured at 90° C. for 1 hour. Transfer of the transfer layer to the no-alkali glass EAGLE2000 manufactured by Corning Japan using the resulting transfer film was attempted. However, peeling occurred after the transfer at the boundary between the adhesive layer and the transfer layer-receiving object due to the insufficient adhesion.

### Comparative Example 4

On the support film prepared by the procedure described in Example 1, a 20% by mass solution of polymethylsilsesquioxane SR-13 (condensation product of a metal alkoxide; composition, methylsiloxane polymer) manufactured by Konishi Chemical Inc. Co., Ltd. in PGPE and a 20% by mass solution of polyphenylsilsesquioxane SR-23 (condensation product of a metal alkoxide; composition, phenylsiloxane polymer) manufactured by Konishi Chemical Inc. Co., Ltd. in PGPE were coated in this order as the composition of the adhesive layer. The coating was conducted under the condition of spin coating at 500 rpm to prepare the transfer film. The transfer layer was transferred to no-alkali glass EAGLE2000 manufactured by Corning Japan by using the resulting transfer film to obtain the laminate provided with a concave-convex structure.

The results of the evaluation of the transfer area rate and the shape retention rate in Examples 1 to 18 and Comparative Examples 1 to 4 are shown in Table 1. In the Examples, both the transfer area rate and the shape retention rate were at least 50%, and both transfer and shape retention were favorable. In Comparative Example 1, transfer was insufficient and shape retention could not be evaluated. In Comparative Examples 2 to 4, transfer of the transfer layer to the transfer layer-receiving object was possible while the shape retention was insufficient and the transferred concave-convex structure became flat by the heat treatment.

TABLE 1

| | Shape retaining layer | | Adhesive layer | | Thickness | | Transfer | Evalu- | Evalu- |
|---|---|---|---|---|---|---|---|---|---|
| | | Hard- | | Hard- | Transfer | Adhesive | layer- | ation of | ation of |
| | | ness | | ness | layer | layer | receiving | transfer | shape |
| | Composition | (GPa) | Composition | (GPa) | (μm) | (μm) | object | area | retention |
| Example 1 | Methylsiloxane | 0.49 | Phenylsiloxane | 0.03 | 2.8 | 0.22 | No-alkali glass | 4 | 4 |
| Example 2 | Methylsiloxane | 0.49 | Phenylsiloxane | 0.03 | 4.3 | 0.71 | No-alkali glass | 4 | 4 |
| Example 3 | Methylsiloxane | 0.49 | Phenylsiloxane | 0.03 | 7.6 | 2.8 | No-alkali glass | 4 | 4 |
| Example 4 | Methylsiloxane | 0.49 | Phenylsiloxane | 0.03 | 0.3 | 0.26 | No-alkali glass | 3 | 4 |
| Example 5 | Methylsiloxane | 0.49 | Phenylsiloxane | 0.03 | 0.1 | 0.05 | No-alkali glass | 4 | 4 |
| Example 6 | Methylsiloxane | 0.49 | Phenylsiloxane | 0.03 | 2.6 | 0.25 | Silicon wafer | 3 | 4 |
| Example 7 | Methylsiloxane | 0.49 | Phenylsiloxane | 0.03 | 2.7 | 0.51 | Sapphire substrate | 3 | 4 |
| Example 8 | Methylsiloxane | 0.49 | Methylphenyl- | 0.07 | 2.9 | 0.3 | No-alkali glass | 3 | 4 |
| | | | siloxane | | | | | | |
| Example 9 | Methylsiloxane | 0.49 | Methylsiloxane | 0.09 | 2.4 | 0.15 | Silicon wafer | 3 | 4 |
| Example 10 | Methylsiloxane + | 0.15 | Methylsiloxane | 0.09 | 2.7 | 1.6 | No-alkali glass | 4 | 4 |
| | aluminum chelate | | | | | | | | |
| Example 11 | Methylsiloxane + | 0.24 | Methylsiloxane | 0.09 | 3.1 | 0.44 | No-alkali glass | 3 | 4 |
| | aluminum chelate | | | | | | | | |
| Example 12 | Methylsiloxane + | 0.15 | Methylsiloxane | 0.09 | 0.7 | 0.22 | No-alkali glass | 3 | 3 |
| | aluminum chelate | | | | | | | | |
| Example 13 | Methylsiloxane + | 0.13 | Methylsiloxane | 0.09 | 2.9 | 0.34 | No-alkali glass | 4 | 3 |
| | zirconium chelate | | | | | | | | |
| Example 14 | Methylsiloxane + | 0.39 | Methylsiloxane | 0.09 | 2.6 | 0.22 | No-alkali glass | 4 | 3 |
| | tetrametho-xysilane | | | | | | | | |
| Example 15 | Methylsiloxane + | 0.41 | Methylsiloxane | 0.09 | 2.5 | 0.24 | No-alkali glass | 4 | 4 |
| | tetrahydro-xysilane | | | | | | | | |
| Example 16 | Tetra-functional | 0.52 | Methylsiloxane | 0.09 | 0.8 | 0.13 | No-alkali glass | 4 | 4 |
| | Siloxane | | | | | | | | |
| Example 17 | Methylsiloxane + | 0.47 | Methylsiloxane | 0.09 | 1.9 | 0.67 | No-alkali glass | 4 | 3 |
| | Titania | | | | | | | | |
| Example 18 | Methylsiloxane + | 0.56 | Methylsiloxane | 0.09 | 3.1 | 0.25 | No-alkali glass | 4 | 4 |
| | Titania | | | | | | | | |
| Comparative | Methylsiloxane | 0.49 | — | — | 3.8 | — | No-alkali glass | 1 | — |
| Example 1 | | | | | | | | | |
| Comparative | — | — | Methylsiloxane | 0.09 | — | 2.8 | No-alkali glass | 4 | 1 |
| Example 2 | | | | | | | | | |
| Comparative | Methylsiloxane | 0.49 | Epoxy adhesive | 0.08 | 10 | 6.8 | No-alkali glass | 2 | 1 |
| Example 3 | | | | | | | | | |

| Comparative | — | Methylsiloxane | 0.09 | 4.1 | 2.5 | No-alkali glass | 4 | 1 |
|---|---|---|---|---|---|---|---|---|
| Example 4 | | Phenylsiloxane | 0.03 | | 1.6 | | | |

### INDUSTRIAL APPLICABILITY

The thus obtained laminate provided with the concave-convex structure has a highly heat-resistant concave-convex structure and, therefore, it can be used as an anti-reflection plate or a light scattering plate to be used in high temperature environment. When the metal of the metal alkoxide is silicon, the laminate can be used as a resist film in etching and, therefore, the laminate can be used in the production of a sapphire substrate provided with a pattern contributing for improvement in the photoextraction efficiency of an LED. The laminate may also be used as a member of a solar battery panel or the like since the laminate can be provided with the concave-convex structure having a photocatalytic property or electroconductivity by adjusting the metal type and mixing ratio.

1-8. (canceled)

9. A method of manufacturing a laminate provided with a concave-convex structure wherein the method manufactures the laminate comprising a transfer layer-receiving object and a transfer layer provided with a concave-convex structure disposed on the transfer layer-receiving object comprising:
preparing a transfer film wherein a transfer layer is disposed on a support film provided with the concave-convex structure, the transfer layer including a shape retaining layer and an adhesive layer, both the shape retaining layer and the adhesive layer containing a condensation product of a metal alkoxide, and the support film, the shape retaining layer, and the adhesive layer being disposed in this order;
contacting the transfer film and the transfer layer-receiving object with each other with the adhesive layer surface of the transfer film facing the transfer layer-receiving object to prepare a laminate including the transfer layer-receiving object and the transfer film, and
removing the support film from the laminate obtained in the second step.

10. The method according to claim 9, wherein the shape retaining layer has a hardness of 0.1 to 2.0 GPa, and the adhesive layer has a hardness of at least 0.01 GPa and less than 0.1 GPa.

11. The method according to claim 9, wherein the adhesive layer has a thickness of 0.01 to 2 μm.

12. The method according to claim 9, wherein the shape retaining layer contains a crosslinking auxiliary agent.

13. A transfer film having a transfer layer disposed on a support film provided with the concave-convex structure, wherein the transfer layer includes a shape retaining layer and an adhesive layer, both the shape retaining layer and the adhesive layer containing a condensation product of a metal alkoxide, and the support film, the shape retaining layer, and the adhesive layer being disposed in this order.

14. The transfer film according to claim 9, wherein the shape retaining layer has a hardness of 0.1 to 2.0 GPa, and the adhesive layer has a hardness of at least 0.01 GPa and less than 0.1 GPa.

15. The transfer film according to claim 13, wherein the adhesive layer has a thickness of 0.01 to 2 μm.

16. The transfer film according to claim 13, wherein the shape retaining layer contains a crosslinking auxiliary agent.
